(19) United States
(12) Patent Application Publication
(10) Pub. No.: US 2006/0016477 A1
(43) Pub. Date: Jan. 26, 2006

(54) Vacuum enhancing check valve

(76) Inventor: Algis Zaparackas, Farmington Hills, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/898,416

(22) Filed: Jul. 23, 2004

(51) Int. Cl. G05D 7/00

(52) U.S. Cl. 137/112

(57) ABSTRACT

A vacuum enhancing check valve for direct connection to a vehicle brake booster which increases the partial vacuum provided thereto and restricts possible air back flow into the brake booster. The valve comprises a venturi for reducing the pressure of air induced to flow between a first air inlet and an air outlet by a partial vacuum at a vehicle engine's intake manifold. By significantly reducing the air pressure, the valve enhances the partial vacuum available for provision to the brake booster. The venturi is also in air communication with a second air inlet directly attachable to the brake booster such that the air pressure at the second air inlet tends toward the enhanced partial vacuum within the venturi. A valve seat and seal member within the valve are cooperative to allow air flow from the second air inlet toward the venturi, but not in the reverse direction.

### FIELDS OF THE INVENTION

The present invention relates, generally, to the fields of check valves and vehicle braking systems and, more specifically, to aspirating check valves for use with vehicle braking system boosters.

### BACKGROUND OF THE INVENTION

Most of today's vehicle power braking systems utilize vacuum developed at the intake manifold of a vehicle's internal combustion engine to assist in their operation. Such vehicle power braking systems, generally, include a brake booster having a housing that encloses a front chamber and a rear chamber which is separated from the front chamber by a moveable wall. The vacuum developed at the intake manifold is communicated to the front chamber by a conduit to create a partial vacuum in the front and rear chambers which suspends the moveable wall. Thereafter, when a driver of the vehicle presses on the vehicle's brake pedal to apply braking, the vacuum provided to the rear chamber is interrupted and the rear chamber is opened to atmospheric pressure, thereby creating a pressure differential across the moveable wall. The pressure differential causes the moveable wall to translate toward the front chamber which, in turn, causes a force to be transmitted by a push rod to a master brake cylinder connected to the brake booster. The force causes the brake fluid to become pressurized and to then be supplied through a conduit to the brake actuators located at the vehicle's front and rear wheels, thus causing braking of the vehicle.

As the vehicle's driver withdraws pressure from the vehicle's brake pedal, air at atmospheric pressure is allowed to flow from the rear chamber toward the front chamber. The air is evacuated from the front chamber by the vacuum developed at the intake manifold, thereby creating a partial vacuum once again in the front chamber and causing the moveable wall to be returned toward its suspended location. A check valve, which may be fixed to the outside of the brake booster housing or located within the brake booster housing, permits the flow of air from the front chamber.

According to certain safety standards established by the U.S. Department of Transportation, the pressure differential across the moveable wall of the brake booster cannot be less than a value specified for a vehicle. Unfortunately, the partial vacuum developed at the intake manifold may be lower under certain conditions and, hence, the pressure differential may not be sufficient at all times during operation of a vehicle for the vehicle to meet such standards. For example, during cold start conditions or when a vehicle's transmission, power steering, or climate control compressor is engaged, a loss of vacuum at the brake booster may occur. Further, a vehicle may use vacuum assist for many other purposes or systems such as climate control blend doors, parking brake release actuation, engine mount modulation, and fuel purge. As a consequence, less vacuum may be available for the vehicle's brake booster.

Therefore, there exists in the industry, a need for a check valve fixable to a brake booster which is operable to aspirate air from the brake booster and to enhance, or increase, the vacuum available to the brake booster, and that addresses these and other problems or difficulties which exist now or in the future.

### SUMMARY OF THE INVENTION

Broadly described, the present invention comprises a vacuum enhancing check valve for direct connection to a vehicle brake booster which increases the partial vacuum provided to the brake booster and restricts the possible back flow of air into the brake booster. The vacuum enhancing check valve, in accordance with an exemplary embodiment thereof, comprises a valve body having a first air inlet port for connection through a conduit to an air intake of a vehicle internal combustion engine, a second air inlet port adapted for direct connection to a brake booster of a vehicle braking system, and an air outlet port adapted for connection through a conduit to an intake manifold of the vehicle internal combustion engine. The valve body defines a venturi therein which allows air to flow between the first air inlet port and the air outlet port in response to the partial vacuum present at the intake manifold and which reduces the pressure of the flowing air to a minimum at a throat portion of the venturi such that the air pressure at the throat portion is lower than the air pressure at the intake manifold. Thus, the partial vacuum present at the intake manifold is enhanced by the venturi to produce a greater partial vacuum at the throat portion of the venturi. By virtue of the throat portion of the venturi being in air communication with the second air inlet port, the air pressure at the second air inlet port tends toward the partial vacuum present at the throat portion, thereby providing a greater partial vacuum to a vehicle brake booster than would, otherwise, be available from the intake manifold.

The valve body, according to the exemplary embodiment, further defines a valve seat therein interposed between the venturi and the second air inlet port. A seal member located within the valve seat is adapted for movement between a first position in which air is induced to flow from the second air inlet port toward the venturi by the reduced air pressure at the throat portion of the venturi and a second position in which air is restricted from flowing from the venturi toward the second air inlet port.

Advantageously, the vacuum enhancing check valve of the present invention attaches directly to the brake booster of a vehicle braking system and enables the flow of air from the front chamber of the brake booster, but not into the front chamber. Thus, the vacuum enhancing check valve eliminates the need for a check valve located within the brake booster to perform the same function. The vacuum enhancing check valve of the present invention also operates as an aspirator to increase the partial vacuum produced by the intake manifold of a vehicle's internal combustion engine for use by the vehicle's braking system and, potentially, by other vehicle devices or systems which require a vacuum assist. Formerly, such vacuum enhancement was performed by an aspirator positioned within a conduit between the intake manifold and braking system of a vehicle. Therefore, the vacuum enhancing check valve also eliminates the need for an aspirator located within a conduit and the need for a conduit extending between the aspirator and brake booster. Hence, the vacuum enhancing check valve replaces at least three or more components within a vehicle, thereby reducing the vehicle's cost and complexity and improving the vehicle's reliability. Further, the relative orientation of the air inlet ports and air outlet port of the vacuum enhancing check valve enables easy insertion of the second air inlet port directly into a brake booster absent interference with a conduit(s) attached before or after such insertion.

Other objects, features, and advantages of the present invention will become apparent upon reading and understanding the present specification when taken in conjunction with the appended drawings.

### BRIEF DESCRIPTION OF THE DRAWINGS

FIG. 1 displays a side, elevational view of a vacuum enhancing check valve in accordance with an exemplary embodiment of the present invention.

FIG. 2 displays a top, plan view of the vacuum enhancing check valve of FIG. 1.

FIG. 3 displays a sectional view of the vacuum enhancing check valve of FIG. 2 taken along lines 3-3 and with the first and second portions separated to improve clarity.

FIG. 4 displays a bottom, plan view of the first portion of the vacuum enhancing check valve of FIG. 1.

FIG. 5 displays a top, plan view of a portion of a vehicle braking system equipped with the vacuum enhancing check valve of FIG. 1.

FIG. 6 displays a left side, elevational view of the portion of the vehicle braking system of FIG. 5.

### DETAILED DESCRIPTION OF THE INVENTION

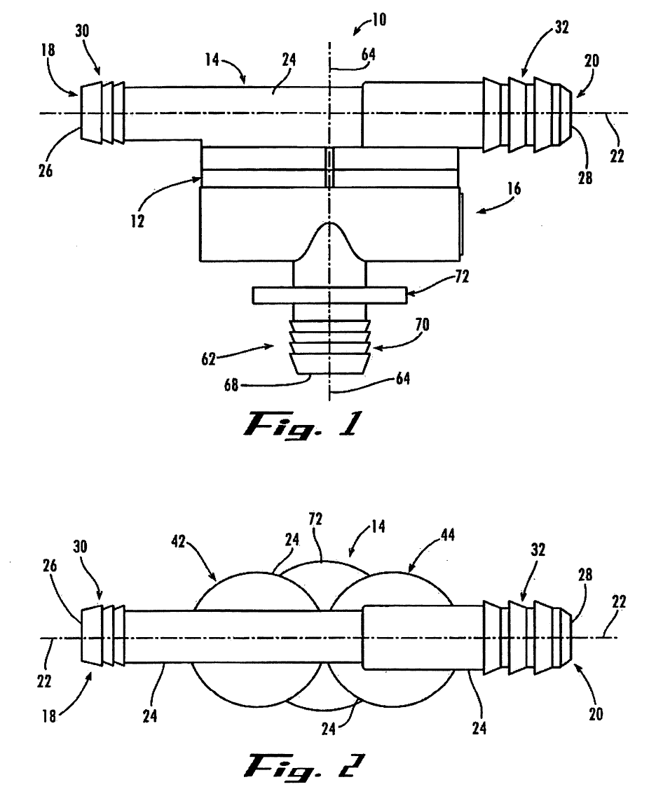

Referring now to the drawings in which like numerals represent like elements throughout the several views, FIG. 1 displays a side, elevational view of a vacuum enhancing check valve 10 in accordance with an exemplary embodiment of the present invention. The vacuum enhancing check valve 10 comprises a substantially one piece valve body 12 which is, generally, formed from a first valve portion 14 and a second valve portion 16 (see FIG. 3). The valve portions 14, 16 are, preferably, manufactured from an injection-molded, heat resistant, rigid plastic which can withstand the forces, pressures, and temperatures present during use attached to a braking system booster in a vehicle's engine compartment. The valve portions 14, 16 are securely joined together during manufacture by sonic welding, heating, or other appropriate method or technique. It should be understood that the valve portions 14, 16 may be manufactured from other suitable plastics, metals, or combinations thereof.

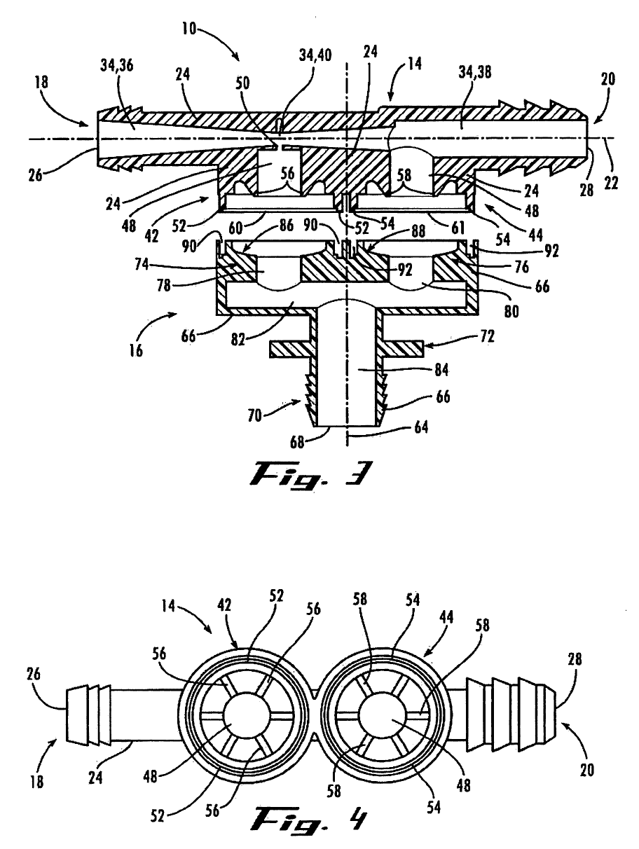

The first valve portion 14 has an air inlet port 18 and an opposed air outlet port 20 which are collinearly disposed along a longitudinal axis 22 extending therebetween as seen in FIGS. 1 and 2. The first valve portion comprises a wall 24 which defines a first opening 26 therein at air inlet port 18 and a second opening 28 therein at air outlet port 20. The first and second openings 26, 28 have a, generally, circular cross-section. The wall 24 has respective pluralities of barbs 30, 32 at air inlet port 18 and air outlet port 20 which extend around the first and second openings 26, 28. The plurality of barbs 30 at air inlet port 18 aid in retaining a conduit, or hose, which is attached to the vacuum enhancing check valve 10 at air inlet port 18 and between air inlet port 18 and a vehicle's air intake snorkel when the vacuum enhancing check valve 10 is in use. Similarly, the plurality of barbs 32 at air outlet port 20 aid in retaining a conduit, or hose, which is attached to the vacuum enhancing check valve 10 at air outlet port 20 and between air outlet port 20 and the intake manifold of a vehicle engine block.

The wall 24 also defines, as illustrated in the sectional view of FIG. 3, a passageway 34 that extends within first valve portion 14 between first and second openings 26, 28. By virtue of the presence of passageway 34, the first and second openings 26, 28 (and, hence, air inlet port 18 and air outlet port 20) are in direct air flow communication. Passageway 34 includes a first portion 36, a second portion 38, and a throat portion 40 which connects the first and second portions 36, 38 for the communication of air therebetween. The first portion 36 extends between the first opening 26 and the throat portion 40, and tapers in cross-sectional area between the first opening 26 and the throat portion 40 such that the cross-sectional area is largest at the first opening 26. Similarly, the second portion 38 extends between a second bore 48 (described below) of a first portion valve seat 42 (described below) and the throat portion 40, and tapers in cross-sectional area between second bore 48 and the throat portion 40 with the largest cross-sectional area of the second portion is present near the second bore 48. Together, the first portion 36, second portion 38, and throat portion 40 comprise a converging-diverging, or venturi, nozzle arrangement which accelerates the velocity of air traveling therethrough, while reducing the air pressure. The maximum air velocity and minimum air pressure are, generally, present at the throat portion 40.

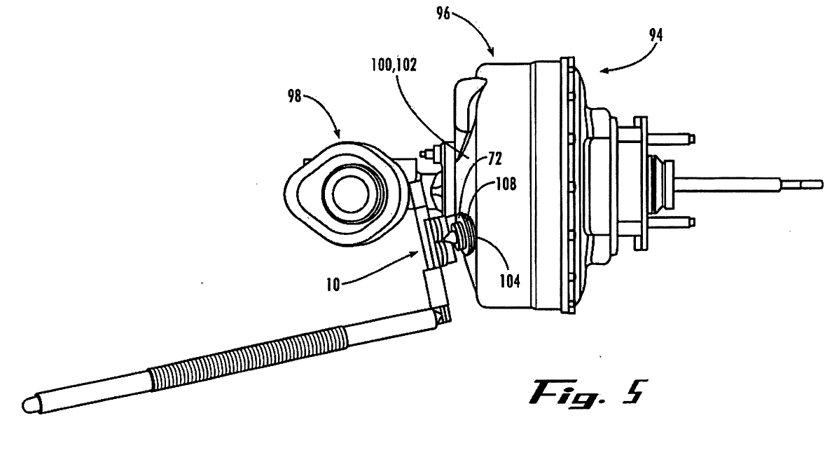

The first valve portion 14 further comprises first portion valve seats 42, 44 which, respectively, include first and second bores 46, 48 defined by wall 24. The first and second bores 46, 48, generally, have circular cross-sections. Wall 24 further defines a channel 50 extending between the first bore 46 and the throat portion 40 of passageway 34 to enable the passage of air between first bore 46 and passageway 34 (and, hence, between first portion valve seat 42 and passageway 34). Second bore 48 is in direct air communication with passageway 34. Wall 24 also has tongues 52, 54 which improve and enable mating of first portion valve seats 42, 44 with second portion valve seats 74, 76 (described below) during joining of the first and second valve portions 14, 16 together. Wall 24 additionally, as viewed best in the bottom plan view of FIG. 4, has protruding fingers 56, 58 which partially extend into the respective first and second bores 46, 48 along angularly spaced apart radii to support flexible, moveable seal members 60, 61. Generally, seal members 60, 61 are relatively thin and have a circular shape.

The second valve portion 16 is adapted to mate with the first valve portion 14 during the manufacture of the vacuum enhancing check valve 10. The second valve portion 16, as displayed in FIGS. 1 and 3, has an air inlet port 62 disposed about a transverse axis 64. According to the exemplary embodiment of the present invention, the transverse axis 64 is perpendicular to longitudinal axis 22. By orienting air inlet port 62 about transverse axis 64 and air inlet port 18 and air outlet port 20 coaxially aligned along longitudinal axis 22, air inlet port 62 may be inserted into a housing 100 of a brake booster 96, as described below, with a conduit attached to air inlet port 18 and a conduit attached to air outlet port 20 absent interference with either conduit. Alternatively, by virtue of such orientation, conduits may be easily attached to air inlet port 18 and air outlet port 20 after insertion of air inlet port 62 into the housing 100 of the brake booster 96. Similarly, by virtue of such orientation, the vacuum enhancing check valve 10 may be readily removed from a brake booster. Thus, the relative orientation of air inlet ports 18, 62 and air outlet port 20 provides substantial flexibility with respect to the insertion and removal of the vacuum enhancing check valve 10 to or from a vehicle brake booster.

The second valve portion 16 comprises a wall 66 which defines an opening 68 therein at air inlet port 62. The openings 68 has a, generally, circular cross-section. The wall 66 has a brake booster interface 70 at air inlet port 62 for improving the retention and securing of air inlet port 62 within an opening 104 and grommet 108 of the housing 100 of a vehicle brake booster 96, as described below, when the vacuum enhancing check valve 10 is in use. In the exemplary embodiment, the brake booster interface 70 comprises a plurality of barbs protruding at air inlet port 62 and extending around opening 68. The wall 66 also has a shoulder 72 which extends around the air inlet port 62 inboard of the brake booster interface 70. The shoulder 72 serves as a stop which limits travel of the air inlet port 62 into the opening 104 and grommet 108 of a housing 100 of a vehicle brake booster 96 during insertion of the air inlet port 62 therein.

As illustrated in FIG. 3, the second valve portion 16 further comprises second portion valve seats 74, 76 which, respectively, include first and second bores 78, 80 defined by wall 66. The first and second bores 78, 80, generally, have circular cross-sections. Wall 66 further defines a chamber 82 extending between the first and second bores 78, 80 and defines a passageway 84 extending about transverse axis 64 within air inlet port 62 between chamber 82 and opening 68. The chamber 82 is in air communication with first and second bores 78, 80 and passageway 84, thereby enabling air to pass between first and second bores 78, 80 and passageway 84 (and, hence, between second portion valve seats 74, 76 and passageway 84). Wall 66, at the second portion valve seats 74, 76, has first and second concave portions 86, 88 with outer diameters which are slightly smaller than the diameters of seal members 60, 61. Wall 66 still further defines first and second grooves 90, 92 therein at second portion valve seats 74, 76 which are complementary to the tongues 52, 54 of wall 24 of the first valve portion 14 and receive the tongues 52, 54 when the first and second valve portions 14, 16 are joined during manufacture of the vacuum enhancing check valve 10.

It should be noted that, in other exemplary embodiments of the present invention, wall 66 may define additional air inlet ports which are in air communication with chamber 82. The additional air inlet ports may be connected to other vehicle devices or systems which may require vacuum or vacuum-assist such as, for example and not limitation, a climate control compressor, climate control blend doors, transmission, cruise control system, parking brake release actuator, engine mount modulator, and fuel purge system.

The vacuum enhancing check valve 10 is assembled by aligning first portion valve seats 42, 44 and second portion valve seats 74, 76 such that the tongues 52, 54 of wall 24 are aligned with grooves 90, 92 of wall 66. Seal members 60, 61 are then positioned in contact with and resting on the protruding fingers 56, 58 of wall 24. The first and second valve portions 14, 16 are subsequently pressed together and joined by sonic welding, heating, or other appropriate method or technique. The particular method or technique used to join the first and second valve portions 14, 16 generally depends on the material from which they are formed.

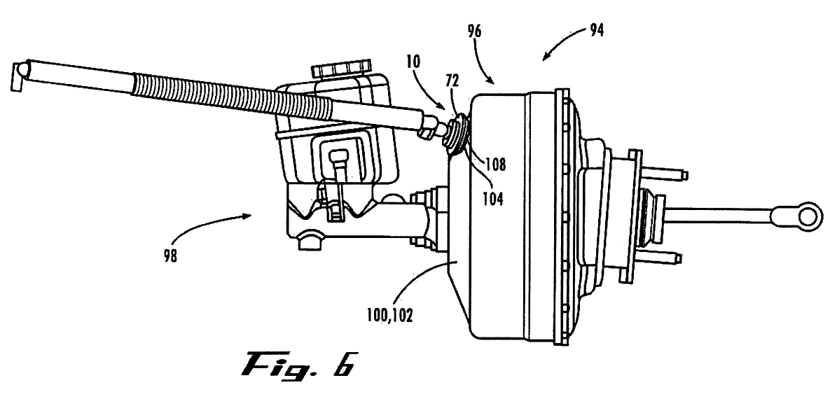

The vacuum enhancing check valve 10 is, generally, for use in conjunction with a vehicle braking system 94 having a brake booster 96 and master cylinder 98 assembly adapted for use therewith as displayed in the top plan and left side, elevational views of FIGS. 5 and 6. Such a brake booster 96 comprises a housing 100 which at least partially encloses front and rear chambers. The front and rear chambers are substantially similar to those found in conventional vehicle braking systems and operate in a substantially similar manner. The housing 100 has a wall 102 which defines an opening 104 therein and a passageway (not visible) therethrough. The passageway (not visible) extends between the opening 104 and the front chamber such that air may pass between the opening 104 and front chamber via the passageway (not visible). A grommet 108 resides within opening 104 for receipt and retention of the air inlet port 62 of the vacuum enhancing check valve 10.

In use, the vacuum enhancing check valve 10 is secured directly to the housing 100 of a vehicle's brake booster 96, as illustrated in FIGS. 5 and 6, by inserting air inlet port 62 into the opening 104 and grommet 108. The grommet 108 aids in preventing the air inlet port 62 from becoming detached from the housing 100 and in sealing the opening 104 so that air does not enter the front chamber of the brake booster 96 from the engine compartment between air inlet port 62 and opening 104. After air inlet port 62 is positioned within opening 104 and grommet 108, a first conduit, or hose, is attached to the vacuum enhancing check valve 10 at air inlet port 18 by pushing the opening in a first end of the first conduit over the plurality of barbs 30 of air inlet port 62 to secure the first end of the first conduit to the vacuum enhancing check valve 10. The second end of the first conduit is then attached to a fitting of a vehicle's air intake snorkel or other air intake device, thereby enabling the flow of air between air inlet port 62 of the vacuum enhancing check valve 10 and the air intake snorkel or device. Next, a second conduit, or hose, is attached to the vacuum enhancing check valve 10 at air outlet port 20 by pushing the opening in a first end of the second conduit over the plurality of barbs 32 of air outlet port 20 to affix the first end of the second conduit to the vacuum enhancing check valve 10. The second end of the second conduit is then secured to a fitting at the intake manifold of the vehicle's engine block, thereby allowing air to flow between the air outlet port 20 of the vacuum enhancing check valve 10 and the intake manifold.

During operation of the vehicle with the vacuum enhancing check valve 10 installed as described above, the vehicle's engine creates a partial vacuum at its intake manifold causing air to flow through the first and second conduits and, hence, through air inlet port 18 and air outlet port 20. As air is drawn through air inlet port 18 toward air outlet port 20, the air is accelerated as it passes through passageway 34 with its velocity being increased and pressure further reduced by the venturi of passageway 34. By virtue of the further reduction in the pressure of the air caused by the venturi, the partial vacuum created by the vehicle's engine is significantly enhanced by the vacuum enhancing check valve 10. The further reduction in pressure (i.e., the significant enhancing of the partial vacuum) within passageway 34 causes the seal members 60, 61 to be drawn against the protruding fingers 56, 58 extending within first and second bores 46, 48 of first portion valve seats 42, 44. With the seal members 60, 61 in such position, air is allowed to flow from chamber 82 to passageway 34 via the first and second portion valve seats 42, 44, 74, 76. As a consequence, air is also drawn into chamber 82 through air inlet port 62, thereby creating a partial vacuum within air inlet port 62 and providing a vacuum assist to the brake booster 96 (and, hence, to the vehicle's braking system).

Typically, a conventional vehicle internal combustion engine creates a partial vacuum of approximately seven inches of mercury (7″ Hg) at its intake manifold during operation. The vacuum enhancing check valve 10 of the present invention enhances this partial vacuum such that the partial vacuum at air inlet port 62 is approximately eighteen inches of mercury (18″ Hg). This enhancement constitutes a 157% increase in partial vacuum which is due, at least in part, to the venturi configuration of passageway 34.

If, for any reason, the direction of air flow is caused to be reversed in chamber 82 and air inlet port 62, seal members 60, 61 are drawn against the first and second concave portions 86, 88 of second portion valve seats 74, 76. Thus, the vacuum enhancing check valve 10 also operates as a check valve similar to those check valves employed within or attached to brake boosters of many vehicle braking systems.

Whereas the present invention has been described in detail above with respect to an exemplary embodiment thereof, it is understood that variations and modifications can be effected within the spirit and scope of the invention, as described herein before and as defined in the appended claims.

What is claimed is:

1. A vacuum enhancing check valve for a vehicle braking system, comprising:
a valve body having a first air inlet port for connection through a conduit to an air intake of a vehicle internal combustion engine, a second air inlet port adapted for direct connection to a brake booster of a vehicle braking system, and an air outlet port adapted for connection through a conduit to an intake manifold of the vehicle internal combustion engine having an air pressure lower than atmospheric pressure, said valve body defining a passageway extending between said first air inlet port and said air outlet port for enabling air to flow from said first air inlet port to said air outlet port in response to the air pressure of the intake manifold, said passageway having a venturi for reducing the pressure of air flowing from said first air inlet port toward said air outlet port, said venturi having a throat portion at which the pressure of air flowing from said first air inlet port toward said air outlet port is at a minimum and is lower than the air pressure of the intake manifold, said valve body further defining a valve seat in air communication with said second air inlet port and said throat portion of said venturi; and,
a seal member located within said valve seat and adapted for movement between a first position in which air is induced to flow from said second air inlet port to said throat portion of said venturi via said valve seat by the reduced pressure of air at said throat portion of said venturi and a second position in which air is restricted from flowing from said throat portion of said venturi to said second air inlet port.

2. The vacuum enhancing check valve of claim 1, wherein said second air inlet port is adapted for direct air communication with a front chamber of the brake booster of the vehicle braking system.

3. The vacuum enhancing check valve of claim 1, wherein said second air inlet port has a brake booster interface for receipt by an opening of the brake booster.

4. The vacuum enhancing check valve of claim 3, wherein said brake booster interface comprises a barb extending from said second air inlet.

5. The vacuum enhancing check valve of claim 1, wherein said second air inlet port has a brake booster interface for receipt by a grommet of the brake booster.

6. The vacuum enhancing check valve of claim 1, wherein said second air inlet port has a shoulder for limiting insertion of said second air inlet port into the brake booster.

7. The vacuum enhancing check valve of claim 1, wherein said vacuum enhancing check valve is operable to replace an aspirator and a check valve found in a conventional vehicle braking system.

8. A vacuum enhancing check valve for a vehicle braking system, comprising:
a first valve portion having a first air inlet port for connection to an air intake of an internal combustion engine and an air outlet port adapted for connection to an intake manifold of the internal combustion engine, said first valve portion defining a venturi therein for enabling air to flow from said first air inlet port toward said air outlet port in response to the air pressure of the intake manifold and for reducing the pressure of air flowing from said first air inlet port toward said air outlet port, said venturi having a throat portion at which the pressure of air flowing from said first air inlet port toward said air outlet port is lower than the pressure of air at the intake manifold, said first valve portion further defining a valve seat in air communication with said throat portion of said venturi;
a second valve portion having a second air inlet port adapted for connection directly to a brake booster of a vehicle braking system, said second valve portion defining a valve seat in air communication with said second air inlet port; and,
a seal member positionable against said valve seat of said first valve portion for allowing the pressure of air at said second air inlet port to tend toward the reduced pressure of air at said throat portion of said venturi and air to flow from said second air inlet port to said throat portion, said seal member being further positionable against said valve seat of said second valve portion for at least partially blocking the flow of air between said second air inlet port and said throat portion of said venturi.

9. The vacuum enhancing check valve of claim 8, wherein said vacuum enhancing check valve is adapted to replace an aspirator for increasing partial vacuum available to a brake booster.

10. The vacuum enhancing check valve of claim 8, wherein said vacuum enhancing check valve is adapted to replace a check valve for limiting the back flow of air into a brake booster.

11. The vacuum enhancing check valve of claim 8, wherein said vacuum enhancing check valve is adapted for insertion into a housing of a brake booster.

12. The vacuum enhancing check valve of claim 9, wherein said vacuum enhancing check valve has a shoulder for limiting the depth of insertion into the housing of the brake booster.

13. The vacuum enhancing check valve of claim 8, wherein said vacuum enhancing check valve has a brake booster interface for securing attachment to a brake booster.

14. The vacuum enhancing check valve of claim 13, wherein said brake booster interface includes a barb extending proximate said second air inlet port.

15. A vacuum enhancing check valve for a vehicle braking system, comprising:
a venturi interposed for air communication between a first air inlet port and an air outlet port, said first air inlet port and said air outlet port being substantially coaxially aligned about a longitudinal axis, said venturi being further interposed between a second air inlet port and said air outlet port, said second air inlet port being aligned about an axis substantially transverse to said longitudinal axis, said venturi being operable to increase the partial vacuum present in an intake manifold of a vehicle engine;
a valve seat interposed in an air communication path between said second air inlet port and said air outlet port; and,
a seal member for interaction with said valve seat, said seal member being movable between a first position in which the increased partial vacuum is made available at said second air inlet port and a second position in which the flow of air out of said second air inlet port is limited substantially.

16. The vacuum enhancing check valve of claim 15, wherein said second air inlet port is positioned relative to said first air inlet port so as to enable insertion of said second air inlet port into a brake booster with a conduit being connected to said first air inlet port.

17. The vacuum enhancing check valve of claim 15, wherein said second air inlet port is positioned relative to said air outlet port so as to enable insertion of said second air inlet port into a brake booster with a conduit being connected to said air outlet port.

18. The vacuum enhancing check valve of claim 15, wherein said vacuum enhancing check valve further comprises a brake booster interface for securing said vacuum enhancing check valve to a brake booster.

19. The vacuum enhancing check valve of claim 18, wherein said brake booster interface comprises a barb extending at least partially around said second air inlet port.

20. The vacuum enhancing check valve of claim 15, wherein said vacuum enhancing check valve further comprises a shoulder for limiting insertion of said vacuum enhancing check valve into a brake booster.
